(19) United States
(12) Patent Application Publication
(10) Pub. No.: US 2004/0246539 A1
(43) Pub. Date: Dec. 9, 2004

(54) Image read apparatus

(75) Inventor: Nobuhito Serita, Matsudo-shi (JP)

Correspondence Address: FOLEY AND LARDNER, SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/456,834

(22) Filed: Jun. 9, 2003

(51) Int. Cl. H04N 1/04

(52) U.S. Cl. 358/498; 358/474

(57) ABSTRACT

An image read apparatus using an image read unit arranged to prevent any transferable contamination on a document from being carried to a read position is provided.

The image read apparatus according to the present invention uses an image read unit 20 that requires no high-friction sheet. In the image read unit 20, a document 11 begins to be forced to contact a read glass plate 21 from a contact forcing area F2 that is forward of image read areas F3 and F4 of the image read unit 20. Therefore, even if there is transferable contamination on the read surface of the document 11, the contamination on the document is removed by adhering to the read glass plate in the contact forcing area F2 or in the image read area F3 before the document reaches the read position RP. Accordingly, no contamination adheres to the read position on the read glass plate. Hence, it is possible to prevent image quality degradation due to the adhesion of contamination to the read position.

### BACKGROUND OF THE INVENTION

1. Field of the Invention

The present invention relates to an image read apparatus and, more particularly, to an image read apparatus having a sheet-through type automatic document feeder.

2. Description of the Related Art

An image read apparatus having a sheet-through type automatic document feeder (ADF) is arranged such that when a document passes over the upper surface of a read glass plate, the document comes closest to the read glass plate at a read position, and an optical reader in an image read unit optically reads the document through the read glass plate. In this case, if there is transferable contamination (e.g. undried glue or ink) on a surface to be read (read surface) of the document, the contamination may adhere to the read position on the read glass plate. As a specific example of the image read unit, one that has a structure as shown in FIG. 7 is known. That is, a document fed in by the cooperation of a read roller 16 and an auxiliary roller 17b is guided so as to be supplied onto a read glass plate 23 by an upper guide plate 51 and a lower front guide plate 22.

An area in the range of 5 mm forward and 5 mm rearward from a read position RP on the read glass plate 23 is defined as an image read area. The upper guide plate 51 and the read glass plate 23 guide the fed-in document horizontally (so that the document is within a vertical range of 0.5 mm). In this case, if contamination adheres to the read position on the read glass plate, the contamination appears undesirably as a striped image after the occurrence of the adhesion thereof, causing the image quality to be degraded. To prevent contamination from adhering to the read position on the read glass plate, the invention disclosed in Japanese Patent Application Unexamined Publication (KOKAI) No. 2001-339571 proposes a technique wherein a high-friction sheet is disposed forward of the read position. The high-friction sheet contacts the read surface of the fed-in document at a position forward of the read position, thereby removing contamination from the read surface of the document.

Of the above-described conventional techniques, the first-mentioned image read unit suffers from the problem that contamination on the document may adhere also to the read position RP because the image read area is narrow, i.e. in the range of 5 mm forward and 5 mm rearward from the read position RP. In the second-mentioned image read unit, a heavy load is imposed on the transport of document because a high-friction sheet is used. Consequently, stable transport of document cannot be ensured.

### SUMMARY OF THE INVENTION

The present invention was made to solve the above-described problems. Accordingly, an object of the present invention is to provide an image read apparatus using an image read unit arranged such that even if there is transferable contamination on a document, the contamination adheres to some member somewhere forward of the read position, thereby preventing the contamination from being carried to the read position without using a high-friction sheet.

To solve the above-described problem, the present invention provides an image read apparatus having a light source for irradiating a document with light to read it; a read glass plate for travelably supporting the document and transmitting the light from the light source to irradiate the document, the read glass plate having an image read area for reading the document; and a guide section provided to extend over and forward of the image read area in the document travel direction to guide the document in cooperation with the read glass plate, the guide section having a contact forcing area for forcing the document to contact the read glass plate.

### DESCRIPTION OF THE DRAWINGS

FIG. 1 is a sectional view showing a first embodiment of the image read apparatus according to the present invention.

FIG. 2 is an enlarged sectional view showing in detail an image read unit used in the image read apparatus shown in FIG. 1.

FIG. 3 is a sectional view showing a modification made to the spacing between an upper guide plate and a read glass plate shown in FIG. 2.

FIG. 4 is an enlarged sectional view showing in detail an image read unit used in a second embodiment of the image read apparatus according to the present invention.

FIG. 5 is a sectional view showing a modification made to the spacing between an upper guide plate and a read glass plate shown in FIG. 4.

FIG. 6 is an enlarged sectional view showing in detail an image read unit used in a third embodiment of the image read apparatus according to the present invention.

FIG. 7 is an enlarged sectional view showing in detail an image read unit of a conventional image read apparatus.

### DESCRIPTION OF THE PREFERRED EMBODIMENTS

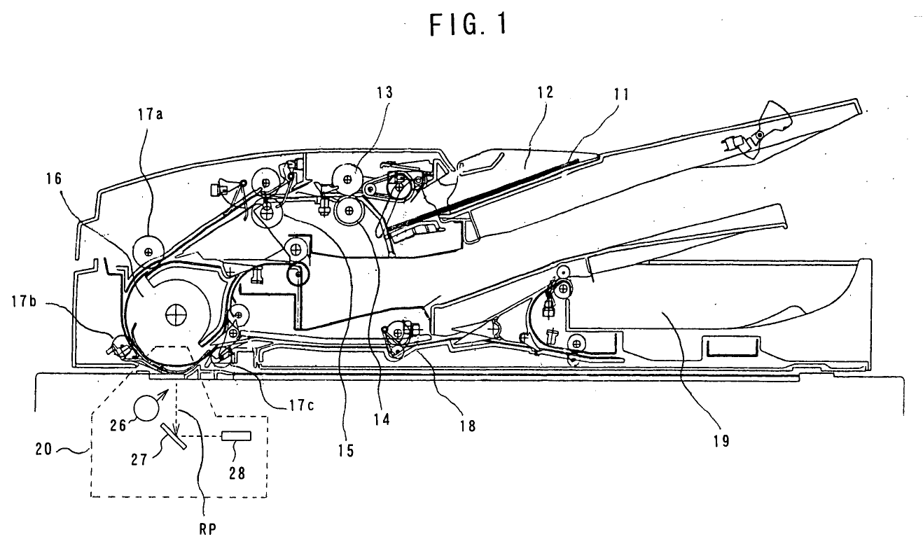

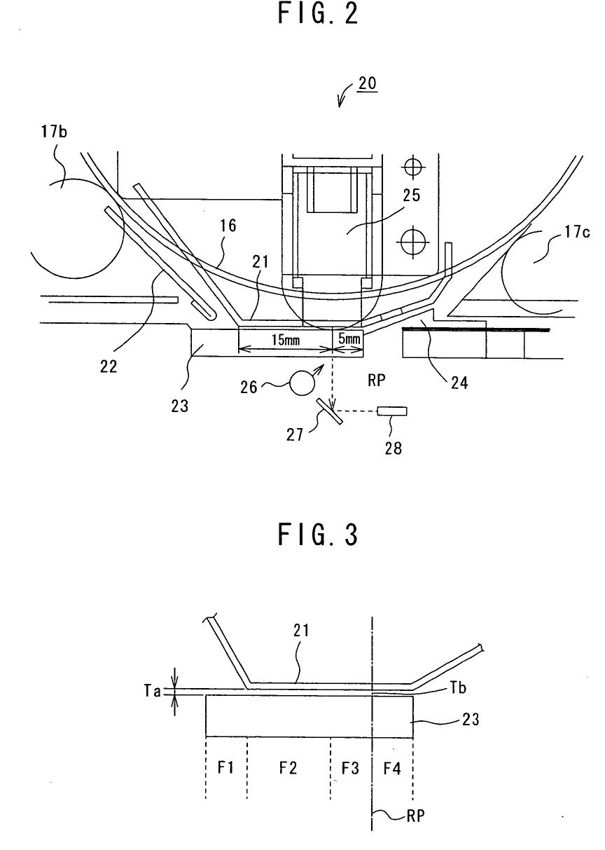

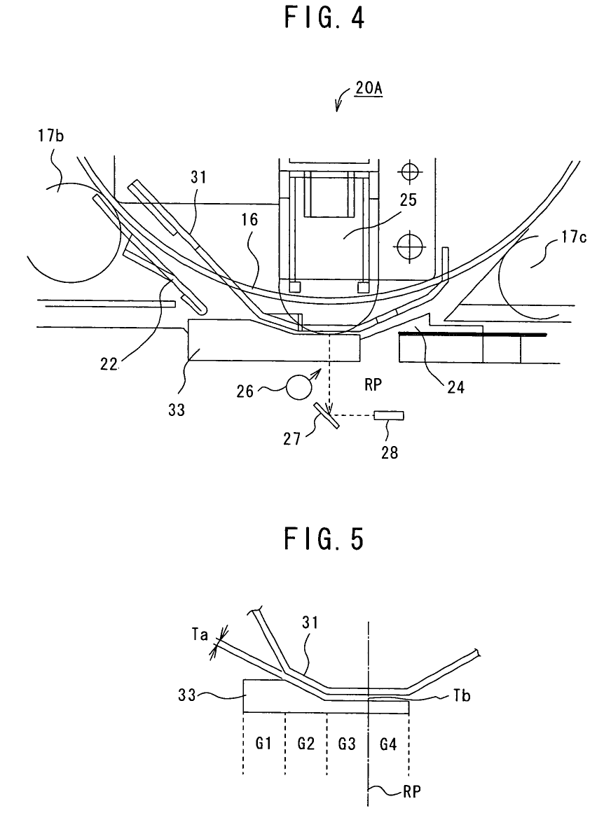

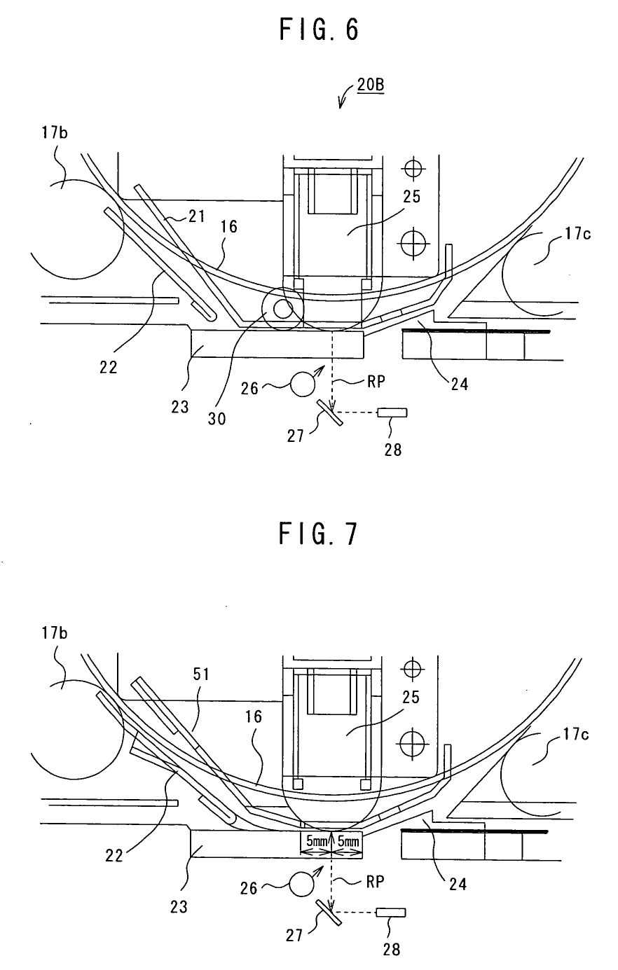

Embodiments of the present invention will be described below with reference to the accompanying drawings. FIG. 1 is a sectional view showing a first embodiment of the image read apparatus according to the present invention. FIG. 2 is an enlarged sectional view showing in detail an image read unit used in the image read apparatus shown in FIG. 1. FIG. 3 is a sectional view showing a modification made to the spacing between an upper guide plate and a read glass plate shown in FIG. 2. FIG. 4 is an enlarged sectional view showing in detail an image read unit used in a second embodiment of the image read apparatus according to the present invention. FIG. 5 is a sectional view showing a modification made to the spacing between an upper guide plate and a read glass plate shown in FIG. 4. FIG. 6 is an enlarged sectional view showing in detail an image read unit used in a third embodiment of the image read apparatus according to the present invention.

(First Embodiment)

The image read apparatus shown in FIG. 1 feeds documents 11 to be read that are set in a document feed section 12, sheet by sheet, by separating them through a feed roller 13 and a separation roller 14. At this time, the transport timing is adjusted by a resist roller 15. The document passing through the resist roller 15 is sent to a read roller 16. The read roller 16 cooperates with three auxiliary rollers 17a, 17b and 17c to pass the transported document 11 over a read position RP in such a manner that the surface to be read of the document 11 faces downward. An image read unit 20 as shown in FIGS. 1 and 2 is disposed around the read position RP to read an image of the document 11 passing the read position RP. The read image is used for the subsequent processing (e.g. coping). The document 11 having passed the read position RP passes through a transport roller 18 and so forth and is discharged to a document discharge section 19.

The image read unit 20 will be described in more detail with reference to FIGS. 2 and 3. The image read unit 20 has the following members constituting a guide section: an upper guide plate 21; a lower front guide plate 22; a read glass plate 23; a lower rear guide 24; a positioning member 25; a light source 26; a mirror 27; and an optical reader 28. The read roller 16 cooperates with the auxiliary roller 17b to feed the document 11 obliquely downward into the space between the upper guide plate 21 and the lower front guide plate 22, thereby allowing the document 11 to pass over the read glass plate 23 disposed below the guide plates 21 and 22. In this case, the upper side of the read glass plate 23 is, as shown in FIG. 3, divided into a document receiving area F1, a contact forcing area F2, an image read area F3 forward of a document read position RP, and an image read area F4 rearward of the document read position RP. In this example, the contact forcing area F2 extends 10 mm in the document travel direction, but the other areas each extend 5 mm.

Over the range of from the contact forcing area F2 to the image read area F4, the upper guide plate 21 extends parallel to the read glass plate 23 with a spacing Tb (about 0.5 mm) therebetween. Regarding the width direction of the document 11, the positioning member 25 regulates the position of the document 11. The upper guide plate 21 and the read glass plate 23 are provided so that the document 11 passes horizontally over the read glass plate 23 at the read position RP. At a position where the document 11 having passed the areas F1 to F4 on the read glass plate 23 comes out, the upper guide plate 21 guides the document 11 obliquely upward in cooperation with the lower rear guide 24 and then delivers the document 11 toward the transport roller 18 and the document discharge section 19 in cooperation with the auxiliary roller 17c. At the read position RP, a light source 26, a mirror 27 and an optical reader 28 are disposed below the read glass plate 23. The light source 26 applies light through the read glass plate 23 to the document 11 passing the read position RP. Reflected light from the document 11 passing over the read glass plate 23 passes through the read glass plate 23 and is reflected by the mirror 27 to enter the optical reader 28, from which it is output as image read data. The image read data output from the optical reader 28 is delivered to the subsequent processing (e.g. copying).

As has been stated above, the dimensions in the document travel direction of the areas F2, F3 and F4, at which the upper guide plate 21 and the read glass plate 23 are parallel to each other, are set so that the areas F2 and F3 extend 15 mm forward from the read position RP and the area F4 extends 5 mm rearward from the read position RP. Basically, these dimensions need to be set so that the document 11 can pass the read position RP horizontally without interference with the image read operation and, at the same time, any transferable contamination on the document 11 adheres to the read glass plate 23 forward of the read position RP, thereby preventing the transferable contamination from contaminating the surface of the read glass plate 23 at the read position RP. In an actual experiment, transferable contamination was capable of being removed very effectively when the parallel area forward of the read position RP was set in the range of 7 to 8 mm. In this example, however, the parallel area was set to 15 mm with a view to enhancing reliability. It should be noted that because no high-friction sheet was used, there was no adverse effect on the transport of the document 11, and the document 11 was allowed to travel smoothly. Further, it was confirmed that the above-described advantageous effect can be further improved if the spacing Tb between the upper guide plate 21 and the read glass plate 23 as set in the conventional arrangement is decreased toward the forward side to a spacing Ta (Ta<Tb), as shown in FIG. 3, to such an extent that there is no interference with the passage of the document 11.

(Second Embodiment)

An image read apparatus according to a second embodiment uses an image read unit as shown in FIG. 4 in place of the image read unit shown in FIGS. 1 to 3. The image read unit 20A shown in FIG. 4 differs from the image read unit 20 shown in FIG. 2 in the configuration of the upper guide plate and the read glass plate. However, the other constituent members of the image read unit 20A are the same as those of the image read unit 20. In FIG. 4, the document 11 fed in by the cooperation of the read roller 16 and the auxiliary roller 17b is guided by the upper guide plate 31 and the lower front guide plate 22 so as to be fed into the space between the read glass plate 33 and the upper guide plate 31. In this case, the upper side of the read glass plate 23 is, as shown in FIG. 5, divided into a document receiving area G1, a contact forcing area G2, an image read area G3 forward of a document read position RP, and an image read area G4 rearward of the document read position RP. In this example, the areas G1, G2, G3 and G4 each extend 5 mm in the document travel direction.

In the document receiving area G1 of the upper guide plate 31, the read glass plate 33 has a horizontal surface, and the upper guide plate 31 guides the document 11 toward the read glass plate 33 at an angle similar to that in the case of the upper guide plate 21 shown in FIG. 2. In the contact forcing area G2, the upper guide plate 31 is formed so as to guide the document 11 toward the read position RP at a gentler angle than in the case of the upper guide plate 21 shown in FIG. 2. The surface of the read glass plate 33 is also formed into a slant surface so as to face parallel to the upper guide plate 31. In the image read areas G3 and G4, the read glass plate 33 has a horizontal surface, and the upper guide plate 31 extends horizontally in parallel to the read glass plate 33. In this case, it is easier for the document 11 to contact the read glass plate 33 in the contact forcing area G2 than in the case of FIGS. 2 and 3. Consequently, contamination on the read surface of the document 11 is removed by adhering to the read glass plate 33. It should be noted that the arrangement was found to be even more effective when the spacing between the upper guide plate 31 and the read glass plate 33 was set to the spacing Tb as in the conventional arrangement in the image read areas G3 and G4 and changed to a spacing Ta narrower than the spacing Tb in the contact forcing area G2, as shown in FIG. 5.

(Third Embodiment)

An image read apparatus according to a third embodiment uses an image read unit as shown in FIG. 6 in place of the image read unit shown in FIGS. 1 to 3. The image read unit 20B shown in FIG. 6 has a pressure roller 30 added to the structure of the image read unit 20. However, the other constituent members of the image read unit 20B are the same as those of the image read unit 20. The areas F1 to F4 on the read glass plate 23 are the same as in the case of FIG. 3. The pressure roller 30 is installed at a position about 10 mm forward of the read position RP (in the contact forcing area F2). In this case, the document 11 fed in by the cooperation of the read roller 16 and the auxiliary roller 17b is guided by the upper guide plate 21 and the lower front guide plate 22 so as to be fed into the document receiving area F1. The document 11 is further fed into the contact forcing area F2 and the image read areas F3 and F4 between the upper guide plate 21 and the read glass plate 23. The pressure roller 30 transports the document 11 under pressure so that the document 11 fed into the contact forcing area F2 moves in close contact with the read glass plate 23. Accordingly, if there is transferable contamination on the document 11, the contamination is likely to be removed by adhering to the read glass plate 23 at the pressure roller 30, which is forward of the read position RP. Consequently, the transferable contamination is prevented from contaminating the surface of the read glass plate 23 at the read position RP even more effectively than in the case of the arrangement shown in FIGS. 1 to 3.

The image read apparatus according to each of the embodiments of the present invention is arranged as stated above. That is, the image read apparatus uses an image read unit that requires no high-friction sheet. In the image read unit, the document begins to be forced to contact the read glass plate from the contact forcing area, which is forward of the image read area. Therefore, even if there is transferable contamination on the read surface of the document, the contamination on the document is removed by adhering to the read glass plate in the contact forcing area or in the image read area before the document reaches the read position. Accordingly, no contamination adheres to the read position on the read glass plate. Hence, it is possible to prevent image quality degradation due to the adhesion of contamination to the read position. The advantageous effect is increased by somewhat narrowing the spacing of the contact forcing area to such an extent that there is no interference with the travel of the document, or by disposing a pressure roll in the contact forcing area.

What is claimed is:

1. An image read apparatus comprising:
a light source for irradiating a document with light to read it;
a read glass plate for travelably supporting the document and transmitting the light from said light source to irradiate the document, said read glass plate having an image read area for reading said document; and
a guide section provided to extend over and forward of said image read area in a document travel direction to guide the document in cooperation with said read glass plate, said guide section having a contact forcing area for forcing the document to contact said read glass plate.

2. An image read apparatus according to claim 1, wherein the read glass plate and an upper guide plate have gently slant surfaces in the contact forcing area so that a document feed angle to the image read area is smaller than a document feed angle to the contact forcing area.

3. An image read apparatus according to claim 1, wherein said contact forcing area is provided with a pressure roller for pressing the document fed against the read glass plate.

4. An image read apparatus according to claim 1, wherein a spacing between the upper guide plate and the read glass plate in a direction of thickness of said document is narrower in the contact forcing area than at a read position.

5. An image read apparatus according to claim 2, wherein a spacing between the upper guide plate and the read glass plate in a direction of thickness of said document is narrower in the contact forcing area than at a read position.

6. An image read apparatus according to claim 3, wherein a spacing between the upper guide plate and the read glass plate in a direction of thickness of said document is narrower in the contact forcing area than at a read position.
